(19) United States
(12) Patent Application Publication
(10) Pub. No.: US 2019/0311384 A1
(43) Pub. Date: Oct. 10, 2019

(54) PERCEPTION ANALYSIS

(71) Applicant: David Brian Bracewell, Richardson, TX (US)

(72) Inventor: David Brian Bracewell, Richardson, TX (US)

(21) Appl. No.: 16/236,998

(22) Filed: Dec. 31, 2018

Related U.S. Application Data
(63) Continuation of application No. 14/943,826, filed on Nov. 17, 2015, now abandoned.
(60) Provisional application No. 62/080,605, filed on Nov. 17, 2014.

(51) Int. Cl. G06Q 30/02

(52) U.S. Cl. CPC G06Q 30/0204

(57) ABSTRACT

Computer-implemented consumer analytics logic accesses, in computer memory, data comprising user-authored text and includes sentic computing logic to identify, in the data, one or more lexical items in the text and determine a meaning for at least a subset of the one or more lexical items, where corresponding lexical units define the meaning determined for each of the subsets of lexical items. A determination is made by the consumer analytics logic as to whether each lexical unit maps to one or more factors in a set of factors of a model, the set of factors defined to include an attitudinal factor, a sociocultural factor, a personal factor, and a behavioral factor. A consumer sentiment is determined to be expressed in the text based on the model and the analysis.

This application is a continuation of U.S. patent application Ser. No. 14/943,826, filed Nov. 17, 2015, and entitled “Perception Analysis”, which claims the benefit of U.S. Provisional Patent Application No. 62/080,605, filed Nov. 17, 2014, the disclosures of which are incorporated by reference herein in their entirety.

### TECHNICAL FIELD

This disclosure relates in general to the field of data analysis and, more particularly, to analyzing text data to automatically determine market intelligence.

### BACKGROUND

Customer analytics involves the analysis of data to attempt to understand or predict customer (or consumer) behavior and help make business decisions, such as through market segmentation and predictive analytics. Information derived from customer analytics can be used by businesses for direct marketing, site selection, customer relationship management, and other purposes. Online commerce has enabled more data to be collected describing customers' interactions with various brands and products. Ecommerce platforms have allowed businesses to obtain information, such as, a given customer's purchasing history, tendencies of certain consumers to purchase like combinations of products and services (e.g., “Consumers who bought this item also purchased . . . ”), other products a customer looked at before deciding to purchase another product, among other examples. Traditional, “brick-and-mortar” marketplaces have also implemented technology to better track customers' purchasing behavior and trends, allowing businesses to predict inventory patterns, preferences of individual stores' customers based on geography and demographic characteristics, among other examples.

In some respects, the quality of customer analytics is dependent on the quality of data obtained that describe aspects of the customers' behaviors. Traditional market research systems are based on techniques involving surveys, questionnaires, focus groups and panels for the collection of data to be analyzed to construct consumer insights. Other data can be obtained at the point-of-sale, such as through customer reward programs, business credit programs, and sales information.

### BRIEF DESCRIPTION OF DRAWINGS

FIG. 1 is a simplified schematic diagram of an example computing system including a consumer analytics system in accordance with at least some implementations;

FIG. 2 is a simplified block diagram of an example system including an example consumer analytics system in accordance with at least some implementations;

FIGS. 3A-3B is a simplified block diagram representing flows and components in connection with an example consumer analytics system in accordance with at least some implementations;

FIG. 4 is a simplified block diagram representing an example generation of a domain signature in accordance with at least some implementations;

FIG. 5 is a flowchart of an example technique for generating a signature for a domain relating to perceptions within the domain;

FIG. 6 is a graphical representation of a multi-factor model; and

FIG. 7 is a flowchart of an example technique for determining sentiment in words of a document.

Like reference numbers and designations in the various drawings indicate like elements.

### DETAILED DESCRIPTION

Current consumer analytics solutions are limited in the information they use and their ability to interpret underlying motivations and perceptions of customers. For instance, data collected through mechanisms such as questionnaires, focus groups, or at point-of-sale offer just a point in time snapshot of consumer behavior and attitudes and reflect only a limited sample of the overall market. Using such techniques, questions are typically predefined, the data source is small in population and duration, and carrying out the “analytics” can be cumbersome and expensive to maintain. Such information collection techniques also tend to fail to provide context for the consumer decisions. Further, analytics applications in general face challenges in determining what consumer-related questions need answers, understanding which questions can actually be answered through analytics, and finding a source of data on which these answers can be extracted. Traditional consumer analytics not only suffer from inadequate data, but are primarily focused on highly quantifiable and relatively simple measures, limiting the types and value of questions that can be answered.

Understanding consumer perception of products, markets, and trends can be particularly useful for businesses seeking to better understand/define market segmentation, identify latent and emerging demand, identify developing trends, optimize product assortment, and more precisely market to consumers, etc. Indeed, the voice of the customer is often loudly pronounced through social media and the reviews they make online about the products they purchase and use and the companies they patron. This social data can be utilized by marketers to answer the who, why, what, where, when, and how surrounding their products. However, current approaches to mining consumer insights from social data mainly focus on the volume of sentiment and its trend over time. Other signals in the data are largely neglected. These signals include preferences, needs, wants, and actions, which may be more directly linked to consumers' attitudes and the social and personal factors that make up their behavior. Further, consumer perception is not a static measurement, but consistently evolves as consumer and societal attitudes develop and adjust. This Specification describes example systems and solutions that can be used to better identify consumer perceptions as well as the evolution of these perceptions within a variety of respective market segments, or domains. Further, such solutions, among other example advantages, can continuously obtain and analyze data to determine such consumer perception patterns as well as shifts in these patterns as they occur in potentially real time. In some implementations, solutions can further utilize a four-factor model (Attitudinal, Sociocultural, Personal, and Behavioral) for mining consumer insights from social data that combines research in consumer and social psychology, discourse processing, and sentiment analysis.

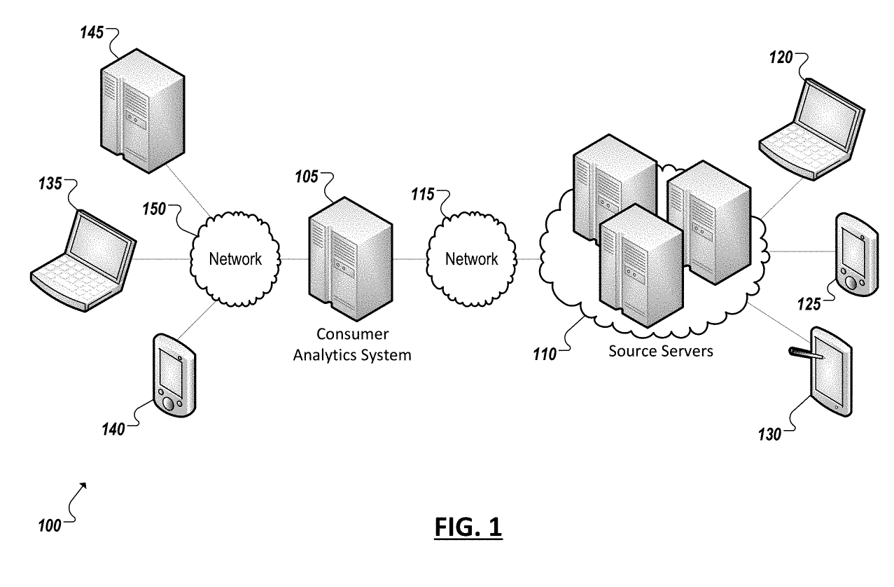

Turning to the example of FIG. 1, a simplified block diagram is shown illustrating an example implementation of a computing system 100 including a consumer analytics system 105 that can include functionality utilizing cognitive computing and deep semantic learning to analyze data available through various public, free, or for-fee data sources 110 using one or more networks (e.g., 115) such as the internet. Source servers 110 can themselves be repositories of this information, including information that is obtained from actual or potential consumers of various goods and services. Source data can include documents, or individual units of information, such as individual webpages, articles, blog posts, user or customer reviews, social network posts, text or instant message posts, discussion board comments, video posts, podcasts, and so on. Indeed, a single webpage, file, or other digital resource may include multiple “documents.” These documents can be produced by journalists, bloggers, or even more casual authors, such as posters to a social network or discussion board, or users of an ecommerce platform providing a product review, among other examples. Accordingly, individual documents can be generated or received from user devices (e.g., 120, 125, 130) and hosted, published, catalogued, or otherwise provided by source servers 110. For instance, a source server can host a platform upon which users can author comments, posts, etc., with the source server storing these documents in its local memory, among other examples.

Consumer analytics system 105 can access (in some cases, using corresponding APIs) source documents from source servers 110. In some instances, consumer analytics system 105 can even obtain some documents directly from users (e.g., from user devices 120, 125, 130) themselves. The consumer analytics system 105 can process raw data to identify “documents,” such as in the case of parsing a webpage comprising multiple blog posts, discussion comments, social network posts, etc. to construct a set of documents corresponding to a given source. Additionally pre-processing can be performed to extract text, structured data, or other useable data from the sources upon which consumer analytics-related activities can be performed. Pre-processing can include converting non-text media, such as images, video, and audio, to text through current and future mechanisms (e.g., optical character recognition, speech-to-text processing, etc.).

Consumer analytics system 105 can provide consumer analytics specific to a particular industry, market, market category, business, or business unit. A corresponding “domain” can be defined to tailor the consumer analytics activities performed by the consumer analytics system 105. A “domain” in this context can correspond to a specific sphere of knowledge, influence, or activity. A domain can be defined based on a request by a particular entity to correspond with the particular scope of the entity's consumer intelligence inquiries or needs. For instance, the domain may correspond to a particular market, a particular product or service category, a particular industry, or some other portion of a market in which consumers participate. The consumer analytics system 105 can identify a subset of the documents accessible to the consumer analytics system 105 (and the sources of such documents) as relevant to the defined domain and designate these as a stream for the domain. Documents collected within this stream can be analyzed to identify words and expressions within the documents and determine and/or apply domain-specific definitions and context to these expressions. From these expressions, domain-specific perceptions can be identified as well as domain-specific patterns in these perceptions. The collection of these patterns of perceptions can be determined and collected to serve as a “signature” for the domain. This signature can be utilized to identify relationships that indicate emerging trends, market segments, and other consumer intelligence.

A variety of users (e.g., at 135, 140) and systems (e.g., 145) can consume analytics results and consumer analytics results provided by consumer analytics system 105 for one or more domains over one or more public or private networks (e.g., 150, including but not limited to the internet). Consumers (e.g., 135, 140, 145) of consumer analytics can be associated with a customer of the provider of consumer analytics system 105 and results and services can be provided that correspond to the particular domain(s) of interest of to (or defined by) the customer. Systems 145 and users 135, 140 can utilize the intelligence and data output by consumer analytics system 105 to engage in additional analyses and activities downstream from the analyses of consumer analytics system 105.

In general, “servers,” “systems,” “clients,” “user devices,” “computing devices,” etc., including the servers, client systems, and other computing devices in example system 100 (e.g., 105, 110, 120, 125, 130, 135, 145, etc.), can include electronic computing devices operable to receive, transmit, process, store, or manage data and information associated with computing system 100. As used in this document, the term “computer,” “computing device,” “processor,” or “processing device” is intended to encompass any suitable processing device. For example, the system 100 may be implemented using computers other than servers, including server pools. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, and computing devices (e.g., 105, 110, 120, 125, 130, 135, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services making use of consumer analytics information from or providing data to consumer analytics system 105, among other examples. Further, in some implementations, servers can be configured to host, serve, or otherwise manage models and data structures, data sets, software service and applications interfacing, coordinating with, or dependent on or used by other services and devices. In some instances, a server, system, subsystem, or computing device can be implemented as some combination of devices that can be hosted on a common computing system, server, server pool, or cloud computing environment and share computing resources, including shared memory, processors, and interfaces.

User, personal, or endpoint computing systems (e.g., 120, 125, 130, 135, 140, etc.) can include traditional and mobile computing devices, including personal computers, laptop computers, tablet computers, smartphones, personal digital assistants, feature phones, handheld video game consoles, desktop computers, smart watches, wearables, internet-enabled televisions, and other devices designed to interface with human users and capable of communicating with other devices over one or more networks (e.g., 150, 180). Attributes of user computing devices, and computing device generally, can vary widely from device to device, including the respective operating systems and collections of software programs loaded, installed, executed, operated, or otherwise accessible to each device. For instance, computing devices can run, execute, have installed, or otherwise include various sets of programs, including various combinations of operating systems, applications, plug-ins, applets, virtual machines, machine images, drivers, executable files, and other software-based programs capable of being run, executed, or otherwise used by the respective devices.

Some computing devices can further include at least one graphical display device and user interfaces allowing a user to view and interact with graphical user interfaces of applications and other programs provided in system 100, including user interfaces and graphical representations of data provided or managed by consumer analytics system 105 as well as programs, services, models, and other resources making use of such data (e.g., at 145). Moreover, while user computing devices may be described in terms of being used by one user, this disclosure contemplates that many users may use one computer or that one user may use multiple computers.

While FIG. 1 is described as containing or being associated with a plurality of elements, not all elements illustrated within system 100 of FIG. 1 may be utilized in each alternative implementation of the present disclosure. Additionally, one or more of the elements described in connection with the examples of FIG. 1 may be located external to system 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

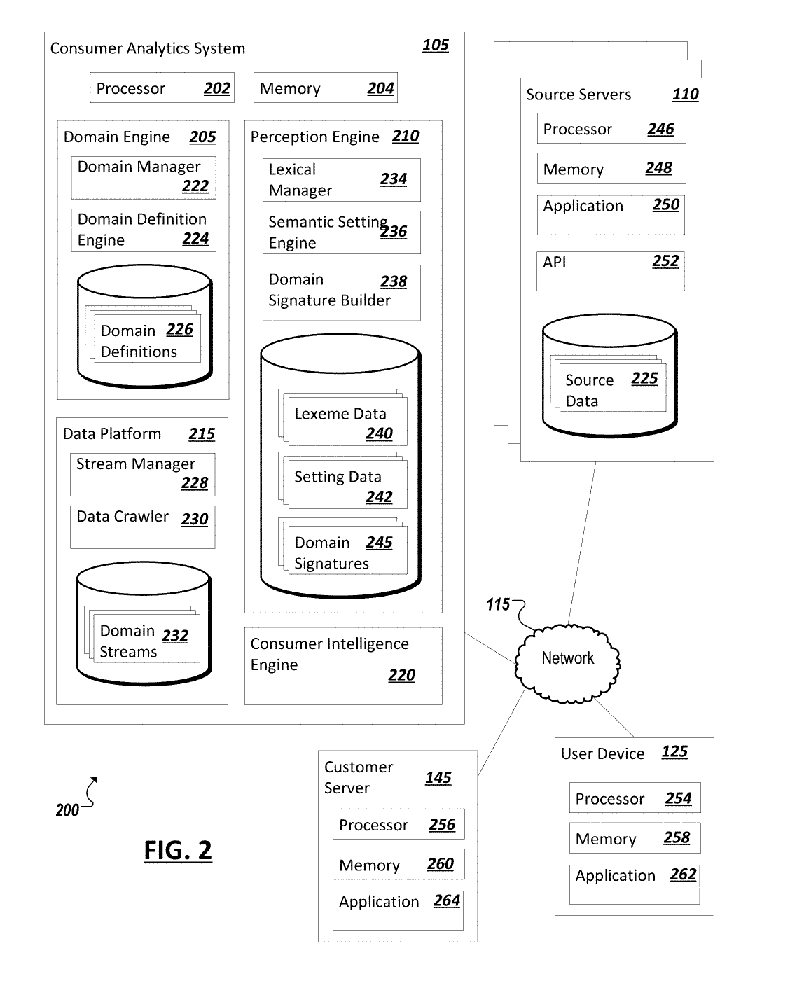

Turning to FIG. 2, a simplified block diagram is shown of an example system 200 including a consumer analytics system 105, source servers 110, one or more user devices 125, and one or more customer servers 145 communicatively coupled using one or more networks (e.g., 115). In one example, consumer analytics system 105 can include one or more processor devices 202, one or more memory elements 204, and one or more logic components implemented in hardware, firmware, and/or software to provide various functionality of the consumer analytics system 105. For instance, components of the consumer analytics system 105 can include a domain engine 205, perception engine 210, data platform 215, and consumer intelligence engine 220, among potentially other examples or combinations of the foregoing.

In one implementation, a domain engine 205 can be provided that includes functionality, such as embodied in domain manager 222 and domain definition engine 224, to generate and use domain definitions 226. For instance, a domain manager 222 can be used to identify which domain definition 226 to apply in connection with activities of one or more other components (e.g., 210, 215, 220) of the consumer analytics system 105, or for which domain a domain definition is to be generated or updated. Domain definitions 226 can be determined, augmented, or generated using a domain definition engine 224. Domain definitions 226 can be based on an identification of a user-provided domain and include the identification of sources, or seeds, relevant to the stream. In some cases, a domain definition 226 can be based at least partially on existing definitions or taxonomies. For instance, a domain definition can be based on information taken from formal categorizations established by a governance organization. The governance organization can range from an industry group (e.g., National Retail Federation, American Medical Association) to international standards organization such as the W3C (World Wide Web Consortium), among other examples. In other examples, domain definitions 226 can be based on taxonomies defined by online communities, including centrally-governed sources (e.g., a centrally-governed social network, an ecommerce site of a particular retailer, etc.) or decentralized sources (e.g., a wiki, decentralized social network, etc.), among other examples. User-defined, or ad hoc domain definitions can potentially duplicate domains already defined externally. In other cases, an ad hoc domain definition can build upon or limit a previously-defined domain. For instance, a user can define a domain as a sub-category of an existing domain, for instance, based on particular attributes of interest to the definer of the domain. As an example, a “Motorized Vehicle” domain may have been previously defined (e.g., either previously by the consumer analytics system 105 or externally) and a user can define a new domain as a sub-domain of “Motorized Vehicle” to cover a subset of vehicles of more particular interest to the user (e.g., vehicles that accelerate 0-60 MPH in less than 4.5 seconds).

Upon defining a domain, sources can be identified that include resources with information that pertains to the domain. For example, resources for a “Motorized Vehicle” domain can include a website or a portion of a website of an automotive magazine, an automotive blog, online car listing websites, discussion boards focused on automobiles, among other examples. These resources can be identified as “seeds” for the domain in that the resources are reliable sources of information relevant to that domain. Such seeds can be identified by crawling online resources and parsing data of the resources to identify terms and phrases relevant to the domain or that correspond with phrases and patterns found in other resources already determined to be seeds for the domains. In some instances, a collection of domain-specific seeds can be identified from a listing of resources (e.g., hyperlinks to other resources) included within another resource. In still other examples, seeds can be manually identified by a user as resources relevant to a defined domain. A listing of such seeds, or a “seed list”, can be defined within each respective domain definition 226.

A data platform 215 of a consumer analytics system 105 can be provided that includes logic (e.g., 228, 230) for generating domain streams 232 comprising domain-specific streams of data collected from the seeds of the domains (e.g., as defined in the respective domain definition 226) as well as other resources (e.g., non-seeds or resources not yet identified as seeds) identified as pertaining to the domain. A stream manager 228 can obtain data from each seed defined for a domain as new data is published at or linked to by the seed. A data crawler (e.g., 230) can be used to identify newly published data as well as spider through links of domain seeds or other resources to identify other resources that include content relevant to the domain. Data from these other resources can also be included in the domain stream 232 of the corresponding domain.

In addition to collecting data from resources relevant to each defined domain, stream manager 232 can process this data to determine whether the data is new or not, as well as determine whether the data is structured, parsable, or otherwise usable by downstream consumer analytics components (e.g., perception engine 210). Additionally, some portions of the data can be determined to be of lesser or no relevance to a domain and can be filtered out. The relevant and parsable portions of the data can be identified and passed through as the domain stream data. Effectively, domain streams 232 can represent up-to-date data describing current parsable data that is of relevance to a corresponding domain.

A consumer analytics system 105 can include a perception engine 210 that can be used to identify consumer perceptions related to a particular one of a set of domain definitions 226. In one example, perception engine 210 can consume a domain stream 232 of the particular domain and parse text and other data of the stream to identify terms and phrases occurring within the domain stream that pertain to consumers' perceptions of products, services, attributes, and ideas of the domain. In one example, perception engine 210 can include logic for determining domain-specific lexicons and contextual use of domain-specific terms and phrases within these lexicons. Patterns can be identified to increase the accuracy of perception analyses for the domains.

In the example of FIG. 2, perception engine 210 can include a lexical manager 234, semantics engine 236, and domain signature builder 238, among potentially other sub-components. In the current example, a lexical manager 234 includes logic for identifying, determining, and defining lexeme data 240 that can define domain-specific lexicons for use in interpreting information included in domain streams 232, as well as identifying other resources that appear to also be relevant to the domain (e.g., based on their use of lexical items consistent with the domain lexicon). In general, a lexicon consists of an inventory of lexical terms. A lexicon can also be commonly referred to as a vocabulary. A lexical term can be either a lexical item or lexical unit (or “lexeme”). Lexical items include words, parts of words or chains of words that together define the lexicon of a language. Lexical units are lexical items that have been paired with their respective meanings. In some cases, a lexical item can be monosemantic in that it has the same meaning regardless of context. Other lexical items can be polysemantic with meanings that vary depending on the context of its use. Indeed, the full meaning, or lexical semantics, of lexical item are typically dependent on the context.

The meaning of a lexical item can also be a product of the domain in which the lexical item is used. A domain lexicon can be the set of lexical units relevant to a corresponding domain. A domain lexicon can be a subset of a root language lexicon. A root language lexicon can be an inventory of all commonly accepted lexical items in a given language. A root language lexicon is filtered and/or augmented to produce a specific domain lexicon based on the particular sphere of knowledge, influence, or activity (i.e., the definition) of a specific domain. For instance, some lexical items included in the root language lexicon may never be used or may otherwise be irrelevant within documents pertaining to a certain domain. Further, some meanings of a particular polysemantic lexical item may be irrelevant to a domain and can be filtered out such that a lexical unit for a given polysemantic lexical item within a particular domain lexicon may only include the domain-relevant meanings of the lexical item.

Lexeme data 240 can include definitions for a root language lexicon, lexical items and units within the root language lexicon, domain lexicons including the lexical units within the respective domain lexicons, among other information. Lexical manager 234 can be used to generate lexeme data 240. In some cases, lexeme data can be gathered from existing knowledge bases, such as pre-existing root language lexicons and collections of lexical items. Lexical manager 234 can also supplement, filter, or modify these root language lexicons to develop a domain lexicon (e.g., based on patterns founds in a corresponding domain stream or corpus). Accordingly, lexical manager 234 can include logic for determining, for each of a plurality of different domains, which lexical items and corresponding lexical semantics are relevant to each domain. For instance, documents in a domain stream (e.g., pre-identified as relevant to a particular domain) can be parsed to identify patterns in the documents and identify the set of lexical items relevant to the particular domain. Supervised machine learning can also be employed to receive user input supplementing and verifying results generated by the lexical manager to identify what meanings of each lexical item are relevant to the particular domain. Further, unique domain-specific meanings for certain lexical items can be identified (e.g., automatically, from definitions included in documents of the domain stream, and/or based on user supervisor feedback) to expand upon lexical units of a root language lexicon. These domain specific lexical unit collections can be defined into a domain lexicon within lexeme data 240 for the particular domain by the lexical manager 234.

As noted above, determining which meaning of a lexical item to apply can be based heavily on the context of its usage. In any given document, the contextual semantics are the overall representation of the author's knowledge of the states of affairs or situations that underlie the meaning of the lexical units used in the document. In other words, contextual semantics provides the meaning of the phrase, sentence, paragraph, and/or document as well as the rationale behind the selection of the specific lexical units. The context of any lexical item is represented through other lexical items (e.g., other modifying or contextual words). The semantic setting of a lexical unit can be the entire context of a given instance of a lexical unit. Each sense of a polysemous word typically has a different semantic setting—the entirety of both the structure and the contents of that structure that describes the meaning of that phrase/sentence/paragraph/document. As an example, the general semantic setting “APPLY HEAT” describes a common (general) circumstance involving a PERSON in an ACTIVITY that involves applying HEAT to a PHYSICAL ENTITY. These additional setting contents can include semantic roles, or setting elements, to indicate that the roles are contextual to the setting of a particular instance of a lexical unit (or phrase/sentence/paragraph/document).

Interpreting context and setting can be influenced by the domain in which a phrase/sentence/paragraph/document appears. Accordingly, in a given domain, specific semantic settings and setting elements can be identified and defined. These semantic settings and setting elements can be the language representation of a particular sphere of knowledge, influence or activity (e.g., the corresponding domain). As an example, the domain specific details for “APPLY HEAT” can vary significantly between domains, such as between a “Cooking Domain” and a “Beauty Domain.” For instance, “APPLY HEAT” can involve a COOK as a person instead of a STYLIST and involve HAIR as a relevant ENTITY (i.e., the entity being heated) instead of FOOD, among potentially limitless other examples. Semantic setting engine 236 can include logic for identifying and determining semantic settings of various words, phrases, paragraphs, etc. of documents, including domain specific documents in domain streams 232. Setting data 242 can be generated to document the semantic settings and setting elements determined by the semantic setting engine.

By determining domain specific lexicons and semantic settings from domain-specific data streams (e.g., 232), insights can be identified relating to perceptions of consumers within the corresponding domains can be identified. A subset of lexical units or phrases within a given domain lexicon can be identifiable as likely pertaining to an expression of a consumer indicating a perception of the consumer within that domain. In some examples, a multi-factor perception, or sentiment, model can be utilized to determine perceptions or sentiments of consumers as included in the data streams. Additionally, subsets of lexical units or phrases can also be determined as likely pertaining to or usable in connection with one or more of the specific factors, such as lexical units and phrases related to attitudinal, sociocultural, persona, and behavioral factors. These subsets can also be domain-specific or otherwise influenced by the domain (and domain lexicon) to which the data stream applies.

In some implementations, the semantic settings of perceptive expressions found within domain streams 232 can be identified and analyzed to determine whether patterns exist within each respective domain as it pertains to consumers' perceptions within the domain. These patterns can be used, for instance, by a domain signature builder 238, to define domain signatures 245 that capture, for any moment in time, consumers' perceptions expressed within domain streams 232, as well as the patterns of these perceptions. In many cases, domain streams 232 can represent an enormous amount of continuously growing and evolving domain-related documents. Consumer intelligence engine 220, and other tools, such as applications (e.g., 262, 264) hosted remotely from consumer analytics system 105 can consume these domain signatures 232 to inform consumer behavior analytics and responses to consumer behaviors identified or predicted from domain intelligence embodied in the domain signatures 245. For example, consumer intelligence engine 220 can utilize the domain signatures to make determinations concerning the sentiment included in stream data collected from a variety of sources.

Consumer intelligence engine 220 can further include logic to mine data collected from the domain steams (e.g., 232) and source data (e.g., 225) for additional (or alternative) insights into consumer sentiment information, which can be determined from the data. For example, in some implementations, consumer intelligence engine 220 (or another tool of consumer analytics system 105) can apply a four-factored model to domain streams and/or source data to determine consumer sentiments or perceptions expressed within the data. As an example, social media data can embody the expressions of consumers ranting, raving, and recommending products, brands, and companies. For consumers reading such feedback (as it appears on the sites of the social media data sources), these represent extra information that can influence their decision on which product or brand to purchase and which company to patron. For companies, social data can represent a potential for insights to the when, where, how, and why their products are used, who is buying them, who is using them, and information about the commenting individuals' associated beliefs, needs, wants, and preferences. These insights can facilitate marketers' understanding of consumer behavior and can be used to better build, design, and market their products and services to meet consumer need and desire.

Traditionally, the volume and trend of positive and negative comments, reviews, tweets, etc. is used as a proxy for brand awareness and placement against competitors (or “competitive intelligence”). An evolution of this is aspect-based sentiment analysis in which sentiment is associated with aspects and higher-level aspect categories for a given target entity, such a product or brand. As an example, in the sentence:

“The screen is big and bright.” a positive sentiment is associated with the aspect “screen” with “big” and “bright” as desirable qualities. “Screen” in turn is linked to a “display” category. However, aspects and sentiment alone do not fully capture the implicatures found in social data, which inform to the attitudes and behavior of the consumers. As additional examples, consider:

1. “I would totally recommend any other laptop over this pile of garbage.”

2. “I know my child needs to know computers to be successful, but I just can't afford a computer.”

3. “For Park Avenue I expected so much more.”

In the first example the reviewer's negative sentiment for the product (laptop) is strong enough that they recommend others to not buy. Recommending or suggesting to others a course of action is a directive speech act, which originates from directive modality, while the polarity of the act is captured through sentiment analysis (e.g. recommending not to purchase would be negative sentiment) the greater implicature is lost, i.e. the loss of a customer and possible loss of other potential customers within their social network). In the second example the commenter expresses a need, such as a cognitive need, for their children to have knowledge of computers. However, they are unable to meet this need because of the cost. While current sentiment-based approaches identify a negative sentiment associated with “cost”, the greater insight is the loss of a customer who desires the product, but lacks the financial resources to obtain it. Finally, in the third example the commenter expresses disappointment as their expectations were not met. Understanding what their expectations were and how and why they were not met facilitates meeting those and others' expectations in the future.

Capturing deeper insights, such as recommendations, preferences, and needs, can involve more than just sentiment analysis. Instead, concepts from dialogue processing and psychology can be combined with sentiment analysis to create a complete model from which all consumer related implicatures can be mined to produce actionable insights. In one implementation, a four-factor model can be defined that incorporates considerations from consumer and social psychology, dialogue processing, and sentiment analysis. In one example, the four factors include: Attitudinal, Sociocultural, Personal, and Behavioral. Such a model can be embodied in the sentiment analysis logic of the consumer intelligence engine 220 (or another tool of consumer analytics system 105). Attitudinal factors can define consumers' beliefs, needs, wants, and preferences. Sociocultural factors can refer to the influence in decision making arising from the consumers' culture and group identity and their role and status in it. Personal factors can include psychographics (e.g. personality) and demographics (e.g. age and gender). Behavioral factors can inform to the motivations, intentions, actions and ability to perform those actions, e.g. buy a new car. These four factors interact and influence one another. For example, personal factors and social factors have direct impacts on beliefs (attitudinal factor) and behavior, among other examples.

Returning to the example of FIG. 2, consumer analytics system 105 can interact with one or more other systems (e.g., 110, 125, 145) over one or more networks 115. The consumer analytics system 105 can interact with various source servers 110 for instance, to obtain source data 225 for use in generating domain streams 232. An example source server 110 can include one or more processor devices 246, one or more memory elements 248, and logic embodied in hardware and/or software for performing various tasks, including tasks relating to serving or otherwise making source data 225 available to consumer analytics system 105.

Computing environments can further include additional devices (e.g., 125, 145) including user devices (e.g., 125) associated with individual users using the internet or another network (e.g., 115). Devices 125, 145 can include one or more respective processor devices 254, 256, one or more memory elements 258, 260, as well as one or more applications or other programs (e.g., 262, 264). Other computing devices can consume (e.g., using application 262, 264) results generated by consumer analytics system 105, such as results derived based on the domain signatures 245 generated by consumer analytics system 105. Computing devices (e.g., 125, 145) can additionally, or alternatively, be involved in the generation of source data 225. For instance, users can author documents using corresponding user devices (e.g., 125). Further, a customer server 145 can provide additional data containing proprietary information obtained for a customer's corresponding business (such as surveys, customer reviews, ecommerce transaction feedback, etc.) that can supplement other documents (e.g., in source data 225) that can be processed to generate domain streams 232, among potentially other examples.

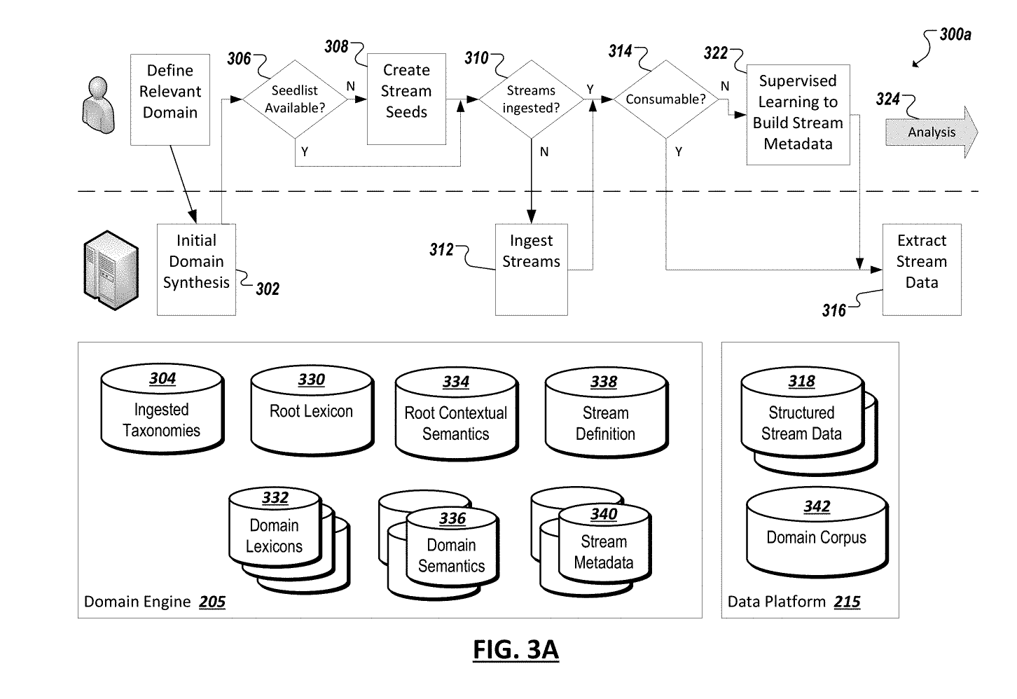

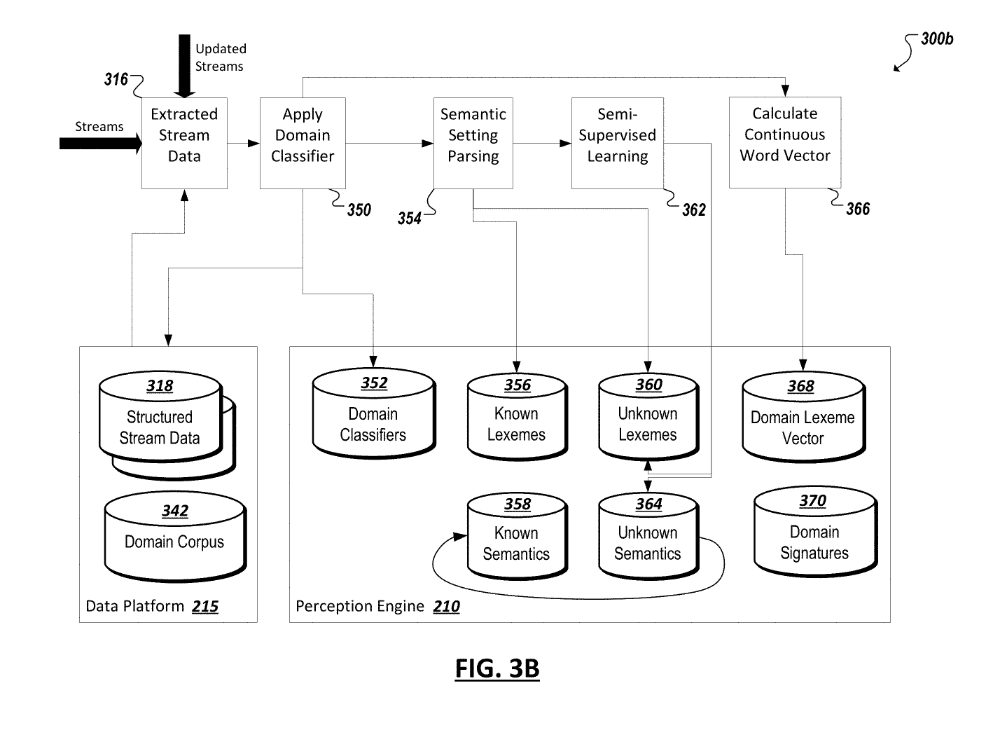

Turning to FIGS. 3A-3B, simplified block diagrams 300a, 300b are shown of an example flow for generating domain signatures 245 and domain signature results for a given domain. In FIG. 3A, a request to define a domain (e.g., of a user) is used to perform an initial domain synthesis 302. Based on information provided by the user, a knowledge base, such as one provided through a trusted online source, can be consulted to determine if a relevant domain has already been defined. In some cases, preexisting ingested taxonomies 304 can be utilized to identify an existing domain or to define a sub- or combined-domain from these preexisting taxonomies.

Upon adequately defining the metes and bounds of the domain consistent with the domain requested by the user, it can be determined whether a seedlist 306 exists for the domain as defined. A seedlist is a set of seeds, or sources, such as a websites, blogs, online magazines, or a portion thereof that have been identified as trusted resources for information and commentary relating to the target domain as defined. In some cases, users can attempt to identify and define at least some of the sources in the seedlist. Sources, or “seeds”, can also be identified from preexisting sources, including wikis, search engine results, among other examples. In some cases, a consumer analytics system can also include functionality for identifying seeds or seed candidates for a domain. For instance, consumer analytics system can include logic to crawl online resources, such as websites and files, to automatically identify and recommend potential seeds for a particular domain's seedlist.

If a seedlist has not been defined or an existing seedlist should be modified before being finalized for a particular domain, new stream seeds and the seedlist can be defined 308 for the domain. The seedlist can inform the consumer analytics system where to source documents that relate to the corresponding target domain. For instance, the consumer analytics system can utilize a crawler or other logic to ingest, or identify, all documents relating to the domain within each of the seeds (e.g., website, social network page, blog, etc.), as well as detect new documents as they are published at each respective seed. A domain stream can be formed from these documents. The domain stream can have an associated “flow”, or temporal element, in that documents are considered based on the date on which they were published, with the newest documents representing the most current portion of the stream. If the seeds in the seed list have not been fully ingested (e.g., at 310), the consumer analytics system can further crawl, or ingest, the seeds (at 312) to obtain the complete set of raw stream data (e.g., copies of at least portions of the webpages, articles, posts, etc. identified during the ingestion step 312.

Upon ingesting the streams, the acquired data can be analyzed to determine whether it is already in structured, or machine parsable, form. For instance, the data can be analyzed to determine whether parsable text data is present in any given portion, or document, within the stream and whether the text data can be extracted (e.g., using optical character recognition (OCR)), among other examples.

The consumer analytics system can process the data obtained from the seeds in a seedlist to extract and define (at 316) structured stream data 318 for the domain. This stream data 318 can embody the domain stream that can serve as the input or data set upon which lexical analysis (e.g., 324) of domain perception can be performed. For instance, turning to FIG. 3B, domain stream data can be provided (and continuously updated) to provide up-to-date information collected for the domain from sources, including source in the domain's seedlist, as well as other sources linked to from these seed sources, among other examples.

With the domain stream data prepared for parsing, perception engine 210 (or other example logic of a consumer analytics system) can process individual documents within the stream for analysis. In some cases, pre-analysis processing can be performed such as correcting spelling, punctuation, conjunctions, abbreviations, etc. In some cases these corrections can be made based on the domain. As an example, abbreviations may be domain specific (e.g., in that the same acronym or abbreviation means something else in another domain). Colloquial expressions contained in the documents, such as in informal discuss board or social media posts, can also be corrected or standardized, or assigned definitions (e.g., “IMO”, “OMG”, “LOL”, etc.). Again, this can be done based on tendencies previously observed or otherwise expected for the particular target domain. Document can be further processed to identify individual words and phrases, or lexical items. Clauses, sentences, and paragraphs can also be identified, for instance, from punctuation or transitional phrases, among other examples. Further, each identified word in a document can be examined by the perception engine 210 to determine its part of speech (e.g., noun, verb, adjective, adverb, etc.).

In some cases, a definition (or set of possible definitions) of a particular lexical item may already be known, as defined in know lexemes 356 previously determined for a given domain. To the extent a lexical item is identified that does not have a known, domain-appropriate definition, the lexical item can be an unknown lexeme (e.g., 360), and semi-supervised machine learning 362 can be employed to identify the appropriate meaning(s) to map to the lexical item within that domain.

Upon identifying lexemes within the domain stream, the context of each lexeme can be determined. For instance, an adjective or adverb can be identified that modifies a given lexeme. A subject can act upon or involve the lexeme and contribute to the context of its use within a given document. In this way, relationships can be identified between nouns, verbs, adjectives, and adverbs within each document. These relationships can be examined across documents in the domain stream to identify statistically significant patterns involving lexemes in the domain corpus. For instance, a particular noun or adjective may reappear a statistically significant number of times within the domain stream. Further, patterns can be identified relating to the context within which that particular noun appears (e.g., a pattern of the actions (verbs) and manner (adjective, adverbs) used to describe the particular noun). Lexical items that are identified as pertaining to the context of a particular lexical unit can be identified as semantic elements for the lexical unit, and these set of semantic elements for a given instance of a lexical unit within a document can embody the semantic setting of the lexical unit. Additionally, trends in the semantic settings for a particular lexical unit can also be identified (e.g., a trend toward describing a particular item a certain way that is different from how it was previously described within the domain, among other examples).

A consumer analytics system can identify statistical relationships between lexical items in a domain stream as well as trends involving these relationships. In some cases, the consumer analytics system can determine resulting semantic settings automatically, without the intervention and input of human users. In other cases, supervised machine learning can be employed, with the consumer analytics system providing sematic setting recommendations and relying, at least in part, on user approval of its recommendations before concluding that its recommendation is correct. This user approval, or feedback, can be used by the consumer analytics system as guidance in future analysis of the domain stream to determine or recommend semantic settings for various lexemes identified in the domain stream. Semantic settings can also be associated with meanings, so as to define how the words embodying the semantic setting are modifying or providing context for a given lexeme. Known semantic settings 358 can be catalogued for the domain, as well as unknown semantic settings 364. Supervised machine learning can be employed to determine whether unknown semantic settings should be associated with a given lexeme within a domain, as well as to determine an associated meaning for the unknown semantic settings (and thus cause the unknown semantic setting to become a known semantic setting).

Upon identifying lexemes and associated semantic settings within a domain, these can be further analyzed to determine whether they relate to consumer perception (or a particular one of a multi-factor sentiment analysis model). For example, lexemes can be identified that are associated with an expression of perception. Such examples could include, depending on the domain, words that describe an objective (or exteroreceptive) modality, such as word describing the appearance, taste, smell, sound, of an item or service. Perception can also be indicated by subjective modality and evidenced by words that indicate a given consumer's subjective opinion or impression of a product of service. Examples could include “that dress looks fabulous”, “the dish was a revelation,” “she has fabulous style,” etc. Such subjective observations can, in some cases, be among the most valuable and information expressions of perception, but without an understanding of the context, these expressions can convey little meaning. For instance, the expression appearing in a document that “she has fabulous style” is of relatively little value until the context of that expression are also considered, such as when this utterance appears in a paragraph also describing the colors, articles of clothing, accessories, etc., “she” was wearing (e.g., in a related photograph) that prompted the conclusive utterance that “she has fabulous style.” These colors, articles of clothing, accessories, etc. can then be associated with the lexeme “fabulous” within this particular domain.

Where lexemes relating to perception are identified in a domain stream with reoccurring identical or similar semantic settings, these “vectors” (e.g., reoccurring semantic settings for a lexeme) can be stored (e.g., 368) for the domain. Such vectors can change or expire, such that the domain lexeme vectors 368 catalogued for the domain represent the most recent trends or perceptions with the domain. Consumer analytics system can archive previously identified lexeme vectors 368 to assist in identifying trends and evolution of perceptions within the domain. Further, the domain lexeme vectors 368 can be used to determine a domain signature 370 for the domain. A domain signature 370 can represent a snapshot of the set of perception-related lexeme vectors within a particular domain. The domain signature can identify lexemes most commonly identified as associated with consumer perceptions within the domain within a period of time. The domain signature 370 can further identify the semantic settings most commonly associated with these common lexemes within the domain to provide context for these perceptions. The domain signature 370 includes valuable information concerning how and potentially why consumers perceive various products and services within a domain. Accordingly, additional tools and logic can process domain signatures 370, including historical domain signature (e.g., of previous time periods) to identify trends, market segments, and gain additional intelligence regarding a particular domain.

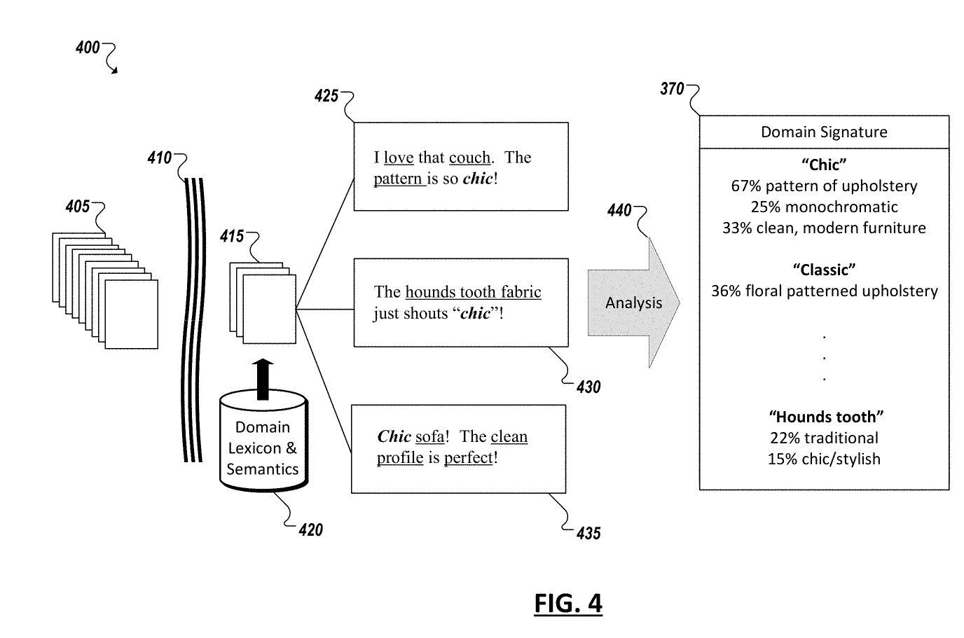

Turning now to the example of FIG. 4, a simplified block diagram 400 is shown illustrating the generation of an example domain signature 370. A consumer analytics system can obtain a wide array of data from a variety of sources for a variety of different domains (including domains yet to be defined). A domain filter 410 can be applied to the corpus of available documents 405 such that only those documents (e.g., 415) relevant to the particular domain (based on the definition of the domain) are to be analyzed in connection with behavior analytics for the particular domain. Likewise, a domain lexicon and domain semantics (e.g., 420) can be obtained, updated, or generated to comprise the subset of lexemes and semantic settings that are relevant to the particular domain. Further, the subset of lexemes and semantic settings can also be associated with domain-specific definitions (or meanings), to the extent their meanings differ from definitions in a root language lexicon.

Applying the domain-specific lexical knowledge (implemented at 420), documents 415 in a domain corpus and/or domain stream can be processed to identify phrases, sentences, and/or paragraphs that include or can be potentially interpreted as expressions of one or more consumers' perceptions relevant to the domain. In this simplified example, three such documents (e.g., 425, 430, 435) can be identified and processed to detect lexemes (e.g., “chic”, “hounds tooth”, etc.) that relate to (in this case a subjective) perceptions of consumers within the particular domain. For instance, in the example of FIG. 4, the particular domain can relate to or be defined as an Interior Design domain, and documents 425, 430, 435 can be identified (among potential thousands of others) that relate to consumers' sensory or subjective perceptions within the Interior Design domain. Other documents may likewise relate to Interior Design, but upon processing (based on domain lexicon and domain semantics 420), may be determined not to include perception-related content.

In the particular example of FIG. 4, multiple documents (e.g., 425, 430, 435) may be identified that include a term (i.e., “chic”) that has been determined to be a lexical item within the Interior Design domain that likely evidences the expression of a domain-related consumer perception. The semantic setting of each usage of the lexical item “chic” can be determined. For instance, in example document 425 the expression “I love that couch. The pattern is so chic!” can be parsed to identify that the words (i.e., lexical items) “couch” and “pattern”, as well as the phrase “I love that couch” are likely related to the author's use of the word “chic”. The meaning of “chic” can be domain-specific and can be influenced by usage of the word as it is identified in the domain corpus. The context of the word's usage, as noted above, can determine its meaning, which in this example, is something positive (e.g., because it follows an author's articulation of loving an item (i.e., the couch) because it possesses a fabric with a pattern the author regards as “chic”). Other documents (e.g., 430) can be identified that also include use of the word “chic” with associated semantic settings that relate to fabric used in interior design (e.g., furniture, rugs, drapery, etc.). While the contents of document 425 and 430 are not identical, the definition of “hounds tooth” within the domain lexicon (420) can be identified as a pattern, allowing consumer analytics system to automatically determine an association between the semantic setting “hounds tooth” in document 430 and the semantic setting “pattern” in document 425. This association can form the basis of a determination that the perceptions of documents 425, 430 are related or consistent. For instance, the consumer analytics system can identify a pattern that consumers within the domain currently perceive patterned fabric, and specifically hounds tooth (among potentially other patterns), as chic (e.g., for furniture and potentially other interior design elements). Other documents (e.g., 435) may not be entirely consistent, and use the same term “chic” within a different context. For instance, semantic settings “clean profile” and “sofa” (and even “perfect”) can be associated with the use of “chic” in document 435, implying that a piece of furniture with clean lines or architectural design is perceived as “chic” by the particular author of document 435, among potentially many other examples.

Continuing with the example of FIG. 4, statistically significant patterns can be identified from the analyses of documents (e.g., 425, 430, 435) that include potential expressions of consumer perception. For instance, a pattern or number of instances of the usage of a particular perception-related lexeme can be identified within the domain stream (e.g., 415) together with a pattern of common or related semantic settings indicating that a particular lexeme was used multiple times within the same or a similar context. For instance, a pattern can be identified based in part on documents 425 and 430 (and potentially many others) indicating that “chic” is a buzzword within the domain during a particular time period, and further indicating that consumers perceive interior design elements as “chic” when they possess a particular pattern, such as hounds tooth. Other patterns can also be identified, including multiple patterns of different usage or context of the same lexical item (e.g., “chic”). These usage patterns can be documented in a domain signature of the particular domain generated by the consumer analytics system.

FIG. 4 includes a representation of an example domain signature 370 to illustrate the type of information that may be included within a domain signature. For instance, the domain signature can document lexemes identified as commonly used within perceptions within the domain during a time period, and further identify one or more semantic settings that tended to accompany the usage of the commonly used lexemes. The domain signature 370 can also identify the relative frequency of a particular lexeme's (and accompanying semantic setting's) use, including the relative frequency a lexeme was used with a first semantic setting (e.g., upholstery pattern) versus a second semantic setting (e.g., clean/modern shape of furniture).

Additionally, a single usage of a particular lexeme can be considered to determine one or more common contexts for the usage of the lexeme. As an example, document 430 associates a hounds tooth pattern with “chic” in the Interior Design domain. Coupled with document 425 (and potentially other documents' use of “chic”) document 430 can contribute to a determination that consumers' perception that something is “chic” in Interior Design is often based on patterned fabric being used. Document 430, based on mentioning the monochromatic pattern of hounds tooth (e.g., defined as both a pattern and monochromatic in domain lexicon 420), can also be determined to be evidence that consumer perceive monochromatic design as “chic.” For instance, a fourth document (not shown) and other documents may include phrases or sentences such as “Black and white color schemes are so chic,” or “Chic monochrome kitchen”, etc. that, when combined with document 430 trigger the consumer analytics engine to determine a pattern between semantic settings with definitions that relate to “monochromatic” as used with instances of the word “chic”. Such can also be reported within domain signature 370, among other patterns identified for the use of the word “chic” as well as the other common perception-related words within the domain.

In some cases, a lexical unit can be a semantic setting for another lexical unit (e.g., that pertains to consumer perception with a domain), as well as be a lexical unit that itself pertains to consumer perception. As an example, in FIG. 4, document 430 may represent one of many documents in corpus 415 that mention “hounds tooth” within the Interior Design domain. As shown in FIG. 4, in one example, a statistically significant subset of the documents mentioning “hounds tooth” may use the term in connection with a perception that something is “chic” or “stylish”, while another subset of the documents mention “hounds tooth” within the context of it being traditional or outmoded. Still other documents may also mention “hound tooth” in other contexts (e.g., expressed by associated semantic settings), although not with the frequency to trigger their inclusion within domain signature 370, among other examples.

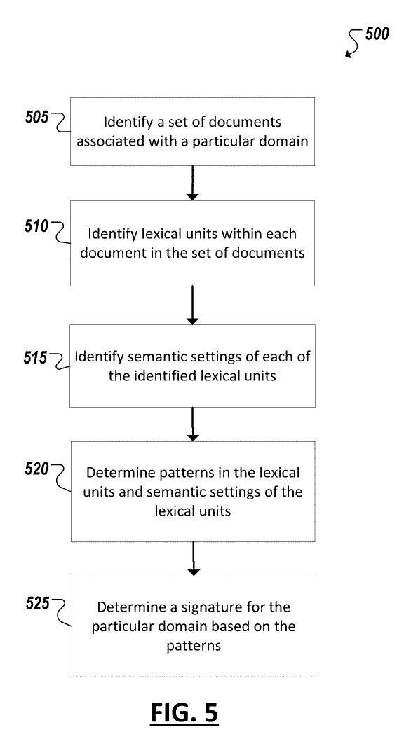

FIG. 5 includes a simplified flowchart 500 illustrating an example technique for a generating a domain signature for a particular domain. A set of documents can be identified 505 as associated with a particular domain. Identifying 505 the documents can include scanning or collecting online resources (e.g., webpages, online files, etc.) from a plurality of different online sources and identifying documents within the resources. The scanned resources can be limited, in some examples, to sources identified as trusted or popular sources of information for the particular domain. Similar corresponding sets of documents can be determined for each of a plurality of different domains.

Documents in a set of a documents for the domain can be parsed to identify 510 lexical units within the document. A lexical unit can be a lexical item (e.g., word, phrase, etc.) paired with a particular meaning. The particular meaning assigned to the lexical unit can be domain-specific, in that it is a meaning commonly used within the domain. Lexical units can be determined based on a domain-specific lexicon cataloguing words and definitions common or accepted within the domain. For each instance of a use of a lexical unit, the semantic settings, or context, of that use can be determined (515). Identifying 515 the semantic setting of each lexical unit can include identifying other lexical items modifying or related to the lexical unit within a document as semantic elements. Patterns in the use and context of lexical units (and their semantic settings) can be determined 520 among the set of documents. For instance, relationships between semantic settings of different instances of a use of a same or similar lexical unit can be identified and determined to provide a common or related context of the lexical unit's use. Further, a pattern can be determined 520 based on a lexical unit appearing within a same or similar context (as expressed by its semantic setting) at a statistically significant frequency, among other examples. A signature for the domain can be determined 525 based on these patterns. For instance, the signature can include information describing at least some of these patterns, such that the signature is defined or determined from the most common uses of various lexical units in the set of documents. In some cases, the signature can be particularly directed toward identifying patterns relating to lexical units (or combinations of semantic setting and lexical unit) that evidence an expression of perception by a consumer within the domain, among other examples.

As noted above, a four-factor model can be applied to sentiment analysis logic incorporated in a consumer analytics system (e.g., 105) to enhance the accuracy and depth of analysis results generated by consumer analytics system. The four-factor model can be fully realized computationally. Indeed, a subset of the model can be automatically identified. In particular, sentences or phrases within online reviews (or other user-generated feedback data), in a numerous variety of sources, can be parsed (e.g., using the techniques described herein) to determine if each sentence contains linguistic manifestations of beliefs about/toward products and experiences, social actions in the form of recommendations, and intentions in the form of promises.

Consumer psychology can provide insights into how thoughts, feelings, and perceptions influence the way individuals buy, use, and relate to products, services, and brands. Drawing from other areas in psychology, such as social psychology, consumer psychology focuses on the cognitive system of consumers using a categorical representation of products, services, brands and other marketing entities. Consumer psychology can be used to find a link between the proto-typicality of a product and consumers' affect toward it. The categories making up of the cognitive system can go beyond just product and brand to encompass goal-directed, cultural, and service categories among others.

Affective computing can be employed to facilitate information retrieval and extraction from corpora social media statements. For instance, pointwise mutual information-information retrieval (PMI_IR) can be used for determining the semantic orientation of phrases mined using syntactic patterns. As an example, to determine if a phrase is positive or negative, computing logic can calculate the semantic orientation of a phrase as the PMI of the phrase and “excellent” minus the PMI of the phrase and “poor” using an information retrieval tool, such as a search engine. In other instances, logic can be configured to use an information extraction approach to discover the sentiment associated with products using lexico-semantic patterns. In other implementations, a combination of positive and negative lexicons (e.g., domain-specific lexicons) and negation rules can be used to identify phrase level polarity. Phrase level polarity can then be combined using a voting mechanism to determine the overall polarity of a news article.

Machine learning techniques can be utilized in a system to result in close to human-level ability for determining sentiment. For instance, machine learning techniques can be facilitated to classify documents as positive or negative polarity. Sentence level subjectivity detection using cut-based classification can also be implemented and used for document level polarity detection. The structure of sentences can also be considered (such as outlined above) to represent and determine the sentiment of each sentence.

In some implementations, a computing system can be provided that is programmatically configured to automatically perform aspect-based sentiment analysis. Aspect-based sentiment analysis can determine sentiment at a finer level of granularity by aiming to determine the sentiment toward aspects of a target entity (e.g., the screen of a TV or the food at a restaurant). Aspect-based sentiment analysis of a sentence can include subtasks such as aspect term extraction, aspect term polarity, aspect category detection, and aspect category polarity. Each aspect term can correspond to, or embody, a respective lexical unit or phrase. The culmination of these subtasks is a system that can identify the aspects of a product as well as the more general category of the aspect (e.g., that “too expensive” belongs to a “price” category) and discover the polarity (positive, negative, neutral, or conflict) toward the aspects and categories. Approaches can include, for instance, BIO tagging and rule-based paradigms, among other techniques. Techniques for aspect polarity detection can include machine learning based techniques that integrate multiple sentiment lexicons to grammar based approaches, among other examples.

Sentic computing can be utilized in some implementations to synthesize common-sense computing, linguistics, and psychology to infer both affective and semantic information about concepts. Semantic evaluation can be enhanced by building effective resources from raw source data to form corpora, dictionaries, and ontologies that can be accessed by a system to determine sentiment from the content of social media sentences. Some corpora, or data streams, exist that can be readily mined and processed. For instance, online reviews represent a rich source of emotion as most consumers have strong opinions about the products they use. Other corpora can exist that can also be processed that include less obvious statements of beliefs, emotions, sentiments, and speculations, among other examples.

Wordnets can be used in some implementations in connection with lexical and semantic resources for sentiment analysis. As an example, WordNet-Affect provides ALabels for a number of synsets in WordNet. The A-Labels include emotion and other concepts, such as moods and emotional responses and are models in a hierarchy similar to WordNet's hyperonym relation. Other WordNet based approaches include SentiWordNet, HowNet, among other examples.

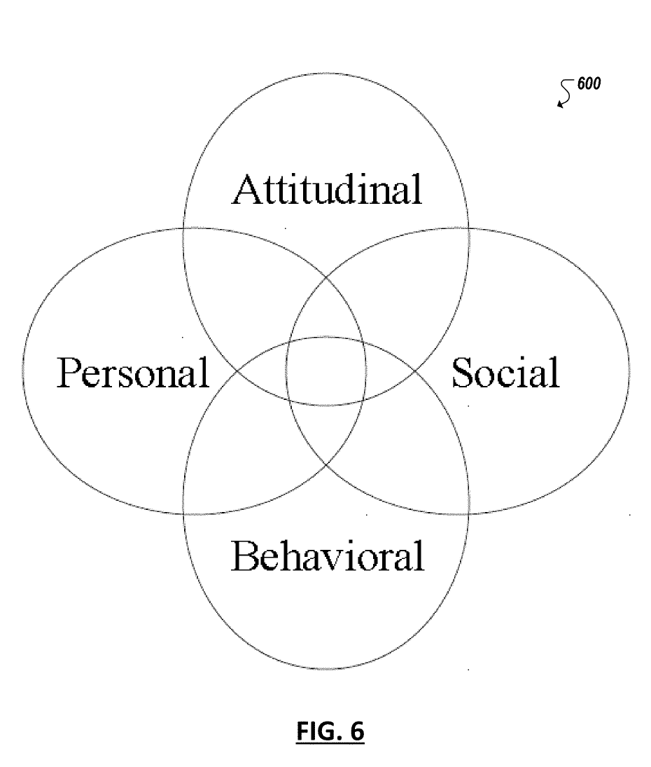

FIG. 6 illustrates a representation 600 of a four-factor model that can be incorporated in a data mining and machine learning system to consider factors of consumer psychology, discourse processing, and sentiment analysis. The four factors inform to consumers' attitudes, behavior, sociocultural self, and personal qualities. They can blend together with each factor interacting and influencing the others as well as, ultimately, the beliefs, needs, and wants of a consumer. Consumers need and desire products and marketers target their products to consumers. In order to create products to fulfill consumer needs, marketers desire insight into the consumer. The four-factor model can be used to obtain these valuable consumer insights. The four factors inform to consumers' attitudes, behavior, sociocultural self, and personal qualities. These factors blend together, with each factor interacting and influencing the others.

The model can consider products or services (e.g., offered in a marketplace) and their corresponding aspects. The product's aspects can be decomposed into two high level categories: products and experiences. Product aspects represent attributes of a product, e.g. screen quality, cost, etc. Experiences relate to the procurement and consumption of products as well as the services, ambiance, and interactions related to a product. Each of these two categories can have multiple sub-categories, which will be market dependent, e.g. display for televisions and transmission for automotives, among other examples.

The Attitudinal factor can represent a consumer's evaluation of a product or brand. Attitudinal factors can correspond to factors that direct consumer behavior and are strong indicators of a brand or product's health and market activity. Four attitudinal components can be defined: 1) Beliefs; 2) Needs; 3) Preferences; and 4) Wants. Beliefs can be feelings held by a consumer about a product or brand. Beliefs may be positive (“The screen is bright”), negative (“The price is too high”), neutral (“The TV is new”), or contradictory (“The TV has great features, but is built poorly”). Beliefs can be modeled using techniques used in aspect-based sentiment analysis and sentic computing. Needs can correspond to desires for a specific benefit, functional or emotional, from a product or service. Needs can be defined, in some implementations, as universal across cultures, however, the propensity of various needs may be culture dependent in some instances. Preferences can define the likes and dislikes, or the tastes, of a consumer. Consumers' preferences can drive the measure of the utility of a product or service. Wants can be defined as the desires for products or services that are not necessary, but for which consumers wish or aspire to.

Sociocultural factors can also be considered and incorporated in logic of a system for parsing text based customer feedback. Sociocultural factors can relate to influences of a consumer's culture and social circle on their personality, attitudes, lifestyle, and behavior. Social influences can directly impact the behavior and attitudes of consumers. Marketers routinely use culture- or group-specific words to better relate their products to particular groups of consumers that correspond to particular sociocultural groupings or classifications. For instance, certain words may be unique to one or more sociocultural profiles, and the use of these words can be utilized to detect, or infer, the sociocultural characteristics of the text's author(s), among other examples.

In some implementations, Sociocultural factors can be broken down into components, including: 1) Cultural; 2) Acceptability; 3) Social Status; 4) Social Role; and 5) Social Action. Cultural can relate to the geographical, historical, and familial influences on the consumer decision making process. Acceptability can indicate the degree to which an action or product adheres to the norms of the consumer's social group (e.g. “eating meat” is unacceptable to “vegans”, etc.). Social Status can relate to the relative status of the consumer within their respective social circle as well as in relation to the product or brand (e.g., “Is a CEO of a Fortune 500 company more likely to buy a Nissan Versa or a Porsche?”). Social Role can define a consumer's role within their circle, such as a “Trendsetter,” “Influencer,” “Follower,” etc. The role of the individual informs to their ability to activate their social network and motivate or influence others based on online feedback authored by the individual. Social Action can relate to actions by an individual to persuade, command, or call to action others in their social circle. A consumer's role, in some implementations, may automatically be deduced (by the consumer analytics system) from other data, such as social network profile data mined from profiles associated with the respective authors of documents, posts, and social media data streams, among other examples.

In some implementations, Personal factors can also be considered and incorporated in logic of a system for parsing text based customer feedback. Personal factors can represent the unique combination of personality, values, and morals that define an individual. In one implementation, personal factors can be broken into components such as Psychographic and Demographics. These components can, themselves, be further sub-categorized. Psychographics can include attempts to study and measure personality, values, opinions, attitudes, interests, and lifestyles. Personality traits can be defined that are correlated with buying behavior. Demographics can define the characteristics of individuals such as their age, sex, sociocultural identity, organic systems, capabilities, etc.

A consumer action can start with a motivation that drives them to purchase, return, or perform some action based on their conscious and unconscious needs and desires. Once the motivation drives a consumer to want to act, that determination is an intention. Consumers who have the ability to act will then perform the action. Behavioral factors can be incorporated into a system to assist in parsing text to identify user perceptions in a marketplace. Behavioral factors can include components such as: 1) Motivation; 2) Intention; 3) Ability; and 4) Action. Motivation can pertain to what drives consumers to identify and buy products or services that fulfill their conscious and unconscious needs and wants. Intention can relate to a determination by the consumer to act in a certain way, such as to switch products or remain loyal. Ability can describe the possession of the necessary skills or means to carry through with an intention (e.g., a teenager may intend to buy a Tesla, but most do not have the ability or resources to do so). Action can define the actions performed by the consumer in regards to a company/product (e.g., purchasing, browsing, inquiring, returning a purchase, etc.).

A system can be provided to parse a corpus of text resources to automatically identify the following components of the four factor model introduced above: (1) Beliefs about/toward a product; (2) Beliefs about/toward an experience; (3) Social actions in the form of recommendations and suggestions; and (4) Intentions in the form of promises to purchase or not purchase a product again. As an example, an aspect-based sentiment analysis can provide polarity and aspect category annotations for sentences in a corpus. The annotations can be used as a starting point to map their aspect categories into product and experience focused beliefs. As an example, data describing restaurant reviews can be processed to map the “price” and “food” categories into product focused beliefs and “service” and “ambiance” categories into experience focused beliefs, among other examples. A corpus can be processed to extend it with annotations of social actions in the form of recommendations and suggestions and intentions in the form of promises. An example of a recommendation is: “I recommend the garlic shrimp, okra, and anything with lamb.” An example of a promise is: “If this computer ever breaks down on me I will most definitely never get the same one again.”

Each review can have zero or more of the components manifested. A multi-label classifier can be constructed made up of multiple one-versus-the-rest logistic regression classifiers. Individual classifiers can use L2 regression with the default cost parameter of 1.0 via the LibLinear library, or another source. Sentic computing-based semantic analysis logic implemented in the system can facilitate features such as:
N-Grams (1G, 2G, 3G): Unigrams, bigrams, and trigrams normalized to lowercase and weighted using Tf-Idf
Learned Vocabulary (V): A dictionary of category specific terms learned during training by ranking unigrams using log-likelihood and selecting the top N. Feature values are normalized using Tf-Idf.
WordNet Domains (WD): Combination of domain and surface form with values normalized by category within a document.
Psycholinguistic Categories (PC): Combination of general Inquirer category and surface form with values normalized by category within a document.
Word Embeddings (WE): Average word vector for words in sentence using the 6b token 300 dimension trained Glove model, or another model.
Deontic Modality (DM): Whether or not the sentence contains a deontic cue word (e.g. should, ought, promise).

Context can also be identified and associated with a particular text review. In some cases, failure to consider sufficient context can cause errors in labeling performed by the system. For example the review “I complain again . . . ” may be mislabeled as an intention, which is not clear without more context. In another example, mislabeling of social actions may occur due to the recommendation/suggestion not being directly related to a product. For instance, in the following review, “If you have a reservation you'll wait for max 5 minutes—so have a drink at the bar.” the suggestion to have a drink at the bar is tangential and not the main thrust of the statement.

Examples of errors for belief (product) include: “Obviously run by folks who know a pie.” and “I really liked this place.” In the case of the first example, pie is a product (food) and one can infer from the sentence that the reviewer thinks the pie at the restaurant was good. This seems to be a place where an annotation is missing from the gold standard. In the case of the second example, the system picks up “place” as a product and the fact that is liked. Errors for belief (experience) include the following review: “The food is uniformly exceptional, with a very capable kitchen which will proudly whip up whatever you feel like eating, whether it's on the menu or not.” In this example, there are a number of hints at an experience, e.g. “proudly whip up” and “on the menu or not”, that cause the system to mislabel. Accordingly, sentences preceding and following a parsed sentence can likewise be parsed for context and the position of the target sentence can be used to identify that the surrounding sentences evidencing a particular context are to apply to the target sentence and influence labeling of the target sentence, among other examples.

As noted above, a computing system can perform a semantic evaluation of various sentences and phrases found in corpora of user-authored social media content to identify and label elements of the phrases that evidence an Attitudinal, Sociocultural, Personal, or Behavioral factor. These terms can then be determined to correspond to a positive or negative sentiment (or polarity). These factors can form the basis of mining consumer insights from social media. As components of the model are realized, a marketer's ability to infer and predict consumer responses to their products and brands can likewise increase.

Machine learning methodologies can be utilized to identify components of the above-described four-factor model. Specifically, a sentence can be parsed (e.g., by semantic evaluation logic of the system) to identify whether or not a sentence contains a linguistic manifestation of one or more of: Beliefs toward products and experiences, Social Actions in the form of suggestions, and Intentions in the form of promises, positive or negative, made toward/about a product or experience. To improve the accuracy of the analysis, a corpus can be further processed to determine context of each sentence to be analyzed for sentiment so as to more fully model the discourse, including factors present before and after the current sentence. Moreover, to determine certain categories of social and personal factors a model of the consumer can be built where a collection of messages is used to classify demographics and their social networks are used to aid in discovering their social role and status.

In some instances, an annotated corpus can be parsed to provide additional context for the user perceptions expressed in the sentences. A system can include an engine to perform such annotations. In other instances, entries in an unannotated corpus can be parsed and analyzed for any one of Attitudinal, Sociocultural, Personal, or Behavioral factors as well as beliefs, social actions, and intentions of a set of persons. These results can be utilized to automatically develop reports, alerts, and other information that can be disseminated to and used by marketing and product research professionals, as well as other computing systems equipped with logic to assist in such business functions. For instance, a client of the consumer analytics system may subscribe to alerts that relate to their respective products/services that are based on corresponding social media posts and reflect sentiment based on any one or all (or a particular combination) of the Attitudinal, Sociocultural, Personal, or Behavioral factors, among other example uses cases.

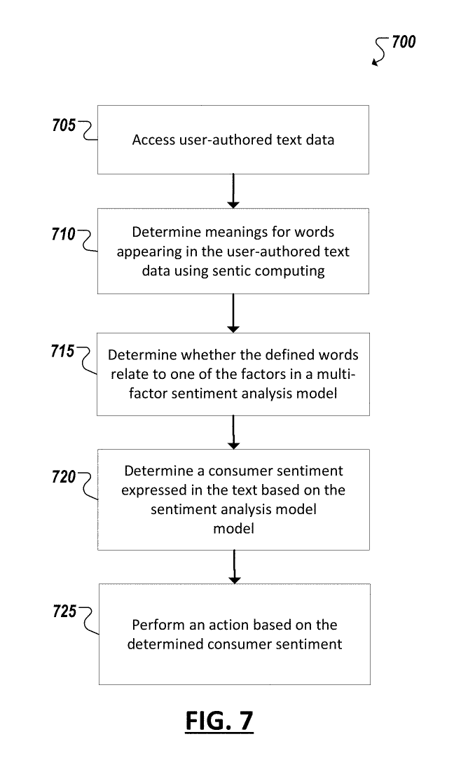

Turning to FIG. 7, a simplified flowchart 700 is shown illustrating an example technique for determining sentiment(s) expressed in user-author text data. A consumer analytics system, implemented entirely by a computing system, can access 705 data that include user-authored texts. The data can be embodied in “documents” or other pieces of text data, such as social media posts, product reviews, discussion board postings, blogs, articles, user comments, or other user-authored text. Sentic computing logic can be used to parse the text and determine 710 the meanings of the words used in the text. In some cases, one or more business domains (or simply “domains”) can be determined to correspond to the text and domain-specific lexicons can be utilized to determine 710 the appropriate definitions of the words (or “lexical items”). A multi-factor semantic analysis model can be used by the consumer analytics system to determine whether (and how) the text relates to expressions of consumer sentiment. The multi-factor model can be defined to consider attitudinal, sociocultural, personal, and behavioral factors. The defined words (or “lexical units”) can be assessed by the consumer analytics system to determine 715 whether they correspond to and inform one or more of the factors of the model. By determining that some of the words correspond to the factors, the consumer analytics system can determine 720 a consumer sentiment expressed by the text and an action can be performed 725 based on the determination. For instance, a positive or negative consumer sentiment detected by the consumer analytics system can be saved, reported, form the basis of an alert (e.g., to the owner of a brand to which the sentiment is detected to apply), trigger generation a customer service ticket, generate an automated customer service response, or form the basis of an automated market analysis, among other example actions.

Although this disclosure has been described in terms of certain implementations and generally associated methods, alterations and permutations of these implementations and methods will be apparent to those skilled in the art. For example, the actions described herein can be performed in a different order than as described and still achieve the desirable results. As one example, the processes depicted in the accompanying figures do not necessarily require the particular order shown, or sequential order, to achieve the desired results. Systems and tools illustrated can similarly adopt alternate architectures, components, and modules to achieve similar results and functionality. For instance, in certain implementations, multitasking, parallel processing, and cloud-based solutions may be advantageous. Additionally, diverse user interface layouts, structures, architectures, and functionality can be supported. Other variations are within the scope of the following claims.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. A computer storage medium can be a non-transitory medium. Moreover, while a computer storage medium is not a propagated signal per se, a computer storage medium can be a source or destination of computer program instructions encoded in an artificially generated propagated signal. The computer storage medium can also be, or be included in, one or more separate physical components or media (e.g., multiple CDs, disks, or other storage devices), including a distributed software environment or cloud computing environment.

Networks, including core and access networks, including wireless access networks, can include one or more network elements. Network elements can encompass various types of routers, switches, gateways, bridges, load balancers, firewalls, servers, inline service nodes, proxies, processors, modules, or any other suitable device, component, element, or object operable to exchange information in a network environment. A network element may include appropriate processors, memory elements, hardware and/or software to support (or otherwise execute) the activities associated with using a processor for screen management functionalities, as outlined herein. Moreover, the network element may include any suitable components, modules, interfaces, or objects that facilitate the operations thereof. This may be inclusive of appropriate algorithms and communication protocols that allow for the effective exchange of data or information.

The operations described in this specification can be implemented as operations performed by a data processing apparatus on data stored on one or more computer-readable storage devices or received from other sources. The terms “data processing apparatus,” “processor,” “processing device,” and “computing device” can encompass all kinds of apparatus, devices, and machines for processing data, including by way of example a programmable processor, a computer, a system on a chip, or multiple ones, or combinations, of the foregoing. The apparatus can include general or special purpose logic circuitry, e.g., a central processing unit (CPU), a blade, an application specific integrated circuit (ASIC), or a field-programmable gate array (FPGA), among other suitable options. While some processors and computing devices have been described and/or illustrated as a single processor, multiple processors may be used according to the particular needs of the associated server. References to a single processor are meant to include multiple processors where applicable. Generally, the processor executes instructions and manipulates data to perform certain operations. An apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, module, (software) tools, (software) engines, or code) can be written in any form of programming language, including compiled or interpreted languages, declarative or procedural languages, and it can be deployed in any form, including as a standalone program or as a module, component, subroutine, object, or other unit suitable for use in a computing environment. For instance, a computer program may include computer-readable instructions, firmware, wired or programmed hardware, or any combination thereof on a tangible medium operable when executed to perform at least the processes and operations described herein. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Programs can be implemented as individual modules that implement the various features and functionality through various objects, methods, or other processes, or may instead include a number of sub-modules, third party services, components, libraries, and such, as appropriate. Conversely, the features and functionality of various components can be combined into single components as appropriate. In certain cases, programs and software systems may be implemented as a composite hosted application. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, applications may represent web-based applications accessed and executed via a network (e.g., through the Internet). Further, one or more processes associated with a particular hosted application or service may be stored, referenced, or executed remotely. For example, a portion of a particular hosted application or service may be a web service associated with the application that is remotely called, while another portion of the hosted application may be an interface object or agent bundled for processing at a remote client. Moreover, any or all of the hosted applications and software service may be a child or sub-module of another software module or enterprise application (not illustrated) without departing from the scope of this disclosure. Still further, portions of a hosted application can be executed by a user working directly at a server hosting the application, as well as remotely at a client.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), tablet computer, a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device, including remote devices, which are used by the user.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include any internal or external network, networks, sub-network, or combination thereof operable to facilitate communications between various computing components in a system. A network may communicate, for example, Internet Protocol (IP) packets, Frame Relay frames, Asynchronous Transfer Mode (ATM) cells, voice, video, data, and other suitable information between network addresses. The network may also include one or more local area networks (LANs), radio access networks (RANs), metropolitan area networks (MANS), wide area networks (WANs), all or a portion of the Internet, peer-to-peer networks (e.g., ad hoc peer-to-peer networks), and/or any other communication system or systems at one or more locations.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

The following examples pertain to embodiments in accordance with this Specification. One or more embodiments may provide an apparatus, a system, a machine readable storage, a machine readable medium, a method, and hardware- and/or software-based logic (e.g., implemented in connection with a shared memory controller) to access, in computer memory, data comprising user-authored text, utilize sentic computing logic, executed by at least one data processing apparatus, to identify, in the data, one or more lexical items in the text and determine a meaning for at least a subset of the one or more lexical items, where corresponding lexical units define the meaning determined for each of the subsets of lexical items. It can further determine whether each lexical unit maps to a set of factors of a model, where the set of factors comprises an attitudinal factor, a sociocultural factor, a personal factor, and a behavioral factor. A consumer sentiment can be determined to have been expressed in the text based on the model.

In some implementations, one or more of the following features can be adopted. It can be determined that one of the lexical items corresponds to a particular product or service and the consumer sentiment can be associated with the particular product or service. It can be determined that the text comprises a linguistic manifestation of consumer beliefs toward the product or service based on the consumer sentiment and a particular one of the lexical units can be determined to map to the attitudinal factor and the consumer sentiment can be determined based on the particular lexical unit being mapped to the attitudinal factor. It can be determined that the text includes a linguistic manifestation of social actions of a consumer based on the consumer sentiment and a particular one of the lexical units can be determined to map to the sociocultural factor and the consumer sentiment can be determined based on the particular lexical unit being mapped to the sociocultural factor. It can be determined that the text includes a linguistic manifestation of intentions of a consumer based on the consumer sentiment and a particular one of the lexical units can be determined to map to the behavioral factor and the consumer sentiment is determined based on the particular lexical unit being mapped to the behavioral factor. It can be determined that the text includes a linguistic manifestation of personality of a consumer based on the consumer sentiment and a particular one of the lexical units can be determined to map to the personal factor and the consumer sentiment can be determined based on the particular lexical unit being mapped to the personal factor.

In some implementations, one or more of the following features can be adopted. It can be determined that a particular one of the lexical units maps to at least one of the factors and a sentiment polarity of the particular lexical unit can be determined based on the sentiment polarity. The sentiment polarity can identify whether the lexical unit corresponds to a negative or a positive sentiment. It can be determined that the text corresponds to a particular one of a plurality of business domains and determining the meaning of each of the lexical items can be based on the particular domain. One or more semantic settings corresponding to the lexical units can be determined, each semantic setting providing context of a corresponding lexical unit based on the particular domain. A signature can then be determined for the particular domain based on the lexical units and semantic settings.

One or more embodiments may provide an apparatus or system that includes one or more processor devices, one or more memory elements, and consumer analytics logic. The consumer analytics logic, when executed by the one or more processor devices, can access, in computer memory, data comprising user-authored text, utilize sentic computing logic to identify one or more lexical items in the text and determine a meaning for at least a subset of the one or more lexical items, where corresponding lexical units define the meaning determined for each of the subsets of lexical items, determine whether each lexical unit maps to a set of factors of a model, and determine a consumer sentiment expressed in the text based on the model. The mode can define the set of factors to include an attitudinal factor, a sociocultural factor, a personal factor, and a behavioral factor.

In some implementations, one or more of the following features can be adopted. The system can further include a library of domain lexicons comprising at least one domain lexicon for each of a plurality of domains, where the lexical units are determined using at least one of the domain lexicons. The system can include a crawler to obtain the data. The crawler can use a seed list defined for a particular domain to identify sources of documents to obtain for the particular domain.

One or more embodiments may provide an apparatus, a system, a machine readable storage, a machine readable medium, a method, and hardware- and/or software-based logic (e.g., implemented in connection with a shared memory controller) to identify a set of documents associated with a particular one of a plurality of domains, where each domain in the plurality of domains corresponds to one or more consumer market segments, identify, in each of the set of documents, one or more respective lexical units, identifying, in each of the set of documents, one or more semantic settings corresponding to the lexical units, where each semantic setting provides context of a corresponding lexical unit, and determine a signature for the particular domain based on the lexical units and semantic settings.

In some implementations, one or more of the following features can be adopted. It can be determined that a particular one of the lexical units corresponds to an expression of a perception by a human author relating to the particular domain. The perception can be based on an objective sensory modality. The perception can be based on a subjective modality. A particular semantic setting can be identified as corresponding to the particular lexical unit. A pattern can be determined within the set of documents corresponding to usage of the particular lexical unit within the context provided at least in part by the particular semantic setting. The pattern can include a threshold number of instances of the particular lexical item within the context. The pattern can be identified in the signature. The signature can identify each of a plurality of lexical units identified as relating to human perceptions within the particular domain and used beyond a threshold frequency within the set of documents. The signature can further identify, for each of the plurality of lexical units, one or more of the contexts of the lexical unit appearing in the set of documents beyond a threshold frequency. Each lexical unit can define a respective lexical item and a meaning of the lexical item relevant to the particular domain. The lexical units can be included in a domain lexicon for the particular domain. The domain lexicon can be generated. The signature can correspond to a period of time associated with authorship of the set of documents. Additional documents associated with the particular domain can be identified and the signature can be updated based on content of the additional documents. The signature can be used to determine one or more consumer behavior characteristics for the particular domain. The one or more consumer behavior characteristics can include one or more of market segmentation of the particular domain, consumer trends within the particular domain, and latent demand within the particular domain. It can be determined, in each of the set of documents, whether lexical units included in the document correspond to one of a defined set of factors included in a multi-factor model, where the factor model comprises attitudinal, sociocultural, personal, and behavioral factors.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results.

What is claimed is:

1. A method comprising:
accessing, in computer memory, data comprising user-authored text;
utilizing sentic computing logic, executed by at least one data processing apparatus, to:
identify, in the data, one or more lexical items in the text; and
determine a meaning for at least a subset of the one or more lexical items, wherein corresponding lexical units define the meaning determined for each of the subsets of lexical items;
determining, using the at least one data processing apparatus, whether each lexical unit maps to a set of factors of a model, wherein the set of factors comprises an attitudinal factor, a sociocultural factor, a personal factor, and a behavioral factor; and
determining a consumer sentiment expressed in the text based on the model.

2. The method of claim 1, further comprising:
determining that one of the lexical items corresponds to a particular product or service; and
associating the consumer sentiment with the particular product or service.

3. The method of claim 2, further comprising determining that the text comprises a linguistic manifestation of consumer beliefs toward the product or service based on the consumer sentiment.

4. The method of claim 3, wherein a particular one of the lexical units is determined to map to the attitudinal factor and the consumer sentiment is determined based on the particular lexical unit being mapped to the attitudinal factor.

5. The method of claim 1, further comprising determining that the text comprises a linguistic manifestation of social actions of a consumer based on the consumer sentiment.

6. The method of claim 5, wherein a particular one of the lexical units is determined to map to the sociocultural factor and the consumer sentiment is determined based on the particular lexical unit being mapped to the sociocultural factor.

7. The method of claim 1, further comprising determining that the text comprises a linguistic manifestation of intentions of a consumer based on the consumer sentiment.

8. The method of claim 7, wherein a particular one of the lexical units is determined to map to the behavioral factor and the consumer sentiment is determined based on the particular lexical unit being mapped to the behavioral factor.

9. The method of claim 1, further comprising determining that the text comprises a linguistic manifestation of personality of a consumer based on the consumer sentiment.

10. The method of claim 9, wherein a particular one of the lexical units is determined to map to the personal factor and the consumer sentiment is determined based on the particular lexical unit being mapped to the personal factor.

11. The method of claim 1, further comprising:
determining that a particular one of the lexical units maps to at least one of the factors; and
determining a sentiment polarity of the particular lexical unit, wherein the consumer sentiment is based on the sentiment polarity.

12. The method of claim 11, wherein the sentiment polarity identifies whether the lexical unit corresponds to a negative or a positive sentiment.

13. The method of claim 1, further comprising determining that the text corresponds to a particular one of a plurality of business domains.

14. The method of claim 13, wherein determining the meaning of each of the lexical items is based on the particular domain.

15. The method of claim 14, further comprising determining one or more semantic settings corresponding to the lexical units, wherein each semantic setting provides context of a corresponding lexical unit based on the particular domain.

16. The method of claim 15, further comprising determining a signature for the particular domain based on the lexical units and semantic settings.

17. A machine-readable storage device comprising code operable, when executed by one or more processors, to:
access, in computer memory, data comprising user-authored text;
utilize sentic computing logic to identify, in the data, one or more lexical items in the text and determine a meaning for at least a subset of the one or more lexical items, wherein corresponding lexical units define the meaning determined for each of the subsets of lexical items;
determine whether each lexical unit maps to a set of factors of a model, wherein the set of factors comprises an attitudinal factor, a sociocultural factor, a personal factor, and a behavioral factor; and
determine a consumer sentiment expressed in the text based on the model

18. A system comprising:
one or more processor devices;
one or more memory elements; and
consumer analytics logic, executable by the one or more processor devices to:
access, in computer memory, data comprising user-authored text;
utilize sentic computing logic to identify, in the data, one or more lexical items in the text and determine a meaning for at least a subset of the one or more lexical items, wherein corresponding lexical units define the meaning determined for each of the subsets of lexical items;
determine whether each lexical unit maps to a set of factors of a model, wherein the set of factors comprises an attitudinal factor, a sociocultural factor, a personal factor, and a behavioral factor; and
determine a consumer sentiment expressed in the text based on the model.

19. The system of claim 18, further comprising a library of domain lexicons comprising at least one domain lexicon for each of a plurality of domains, wherein the lexical units are determined using at least one of the domain lexicons.

20. The system of claim 18, further comprising a crawler to obtain the data.

21. The system of claim 20, wherein the crawler is to use a seed list defined for a particular domain to identify sources of documents to obtain for the particular domain.
